(19) United States
(12) Patent Application Publication
(10) Pub. No.: US 2005/0163350 A1
(43) Pub. Date: Jul. 28, 2005

(54) Fingerprint sensing apparatus and method using time-variable propertz of fingerpring signal

(75) Inventors: Won-Chan Kim, Seoul (KR); Dong-Jin Min, Seoul (KR)

Correspondence Address: BACON & THOMAS, PLLC, 625 SLATERS LANE, FOURTH FLOOR, ALEXANDRIA, VA, 22314, US

(73) Assignee: MELFAS CO. LTD, Seoul (KR)

(21) Appl. No.: 10/506,244

(22) PCT Filed: Jun. 12, 2002
(86) PCT No.: PCT/KR02/01110

(30) Foreign Application Priority Data
Mar. 9, 2002 (KR) 2002/12756

(51) Int. Cl. G06K 9/00

(52) U.S. Cl. 382/124

(57) ABSTRACT

Disclosed are fingerprint sensing apparatus and method using a time-variable characteristic of a fingerprint signal which generates an analog fingerprint signal reflecting charging or discharging characteristic of fingerprint impedance by supplying or discharging electric charge to/from a sensing electrode and converts the analog signal into a digital value on the basis of time required for the analog fingerprint signal to reach a predetermined level. The fingerprint sensing apparatus may reproduce a specific fingerprint pattern at each sensing point by signaling the converted digital value.

### TECHNICAL FIELD

The present invention relates to a fingerprint sensing apparatus, and more particularly to a semiconductor fingerprint sensor for detecting an inherent pattern of a fingerprint by using minute difference of the fingerprint impedances according to valley and ridge of the fingerprint.

### BACKGROUND ART

The fingerprint sensing and matching technique is reliable for personal identification or verification, and used in various fields. A fingerprint sensing method currently used in the fingerprint identification system may be classified into an optical way and a semiconductor way, in broad.

The optical fingerprint sensor uses an image processing system which scans rays to a fingerprint, extracts an inherent characteristic of the fingerprint and then compares it with well-known reference fingerprint characteristics. This image processing system generally has an optical sensor for converting the fingerprint information into digital waveforms. In addition, the image processing system requires an optical device, for example a laser source, a condenser and so on.

Conventionally, there have been published many patents disclosing such an optical fingerprint sensor. For example, U.S. Pat. No. 4,210,899 discloses an optic scanning fingerprint reader associated with a central processing station for the purpose of the usage in security access applications which, for example, allow the approach of a person to a certain location or allow the access to a computer terminal.

U.S. Pat. No. 4,525,859 discloses a video camera for determining whether a fingerprint is matched with an existing fingerprint database by use of details of the fingerprint, i.e., branches and terminations of the fingerprint ridges.

U.S. Pat. No. 4,582,985 discloses a fingerprint verification system made in an approximate size of a common credit card.

The optical fingerprint sensor has an advantage that it shows good structural endurance since this sensor is not directly contacted with fingerprints. However, it needs so much cost to make optical devices having accuracy and accumulation required for the optical fingerprint identification system. In addition, when a picture or a mold of the fingerprint is used, this optical fingerprint sensor may hardly discriminate truth or falsehood.

The semiconductor fingerprint sensor uses the difference of electrical characteristics according to the shape of valley and ridge of the fingerprint. When the fingerprint is contacted with the sensor, there is formed a minute impedance between the fingerprint and the semiconductor fingerprint sensor, which is called ‘fingerprint impedance’ in this specification.

The semiconductor fingerprint sensor is easily made in a small size, and thus suitable for portable or small devices since most components of the sensor may be loaded on a semiconductor wafer. In addition, since this sensor uses the electrical characteristics of the actual fingerprint, a picture or a mold of the fingerprint may not be possibly recognized. This ensures the security system having higher security level than the optical one.

However, the semiconductor fingerprint sensor may have a weak durability since it should be directly contacted with fingerprints.

FIG. 1 is a schematic functional diagram showing a fingerprint sensing system of U.S. Pat. No. 6,052,475 issued to Eric L. Upton in the title of “fingerprint detector using ridge resistance sensing array”.

As shown in FIG. 1, the conventional semiconductor fingerprint sensing system 10 includes a skin resistance sensing array 20 having 10 sensing elements 16 which configures 2×5 array. The sensing elements 16 are arranged in rows and columns. The sensing array 20 is made by forming a conductive layer 22 upon an insulation layer 24, which may be used as an supporting structure for the system. In addition, the conductive layer 22 and the sensing elements 16 form an upper surface of the skin resistance sensing array 20, and the fingertip 12 is drawn along this surface.

A first resistor 28 is connected to both a positive (+) terminal of a voltage source 26. A negative (−) terminal of the voltage source is connected to the conductive layer 22. 10 conductive wires 18 are respectively connected to an input terminal of a multiplexer 30, which is a short-circuit switching device for selectively perfecting a circuit reaching the first resistor 28. This multiplexer is selectively switched by a processor through a selection line in a sequential order of 1˜10.

In addition, a voltage divider circuit formed by the sensing array 20 configures a second variable resistor connecting the conductive layer using the fingertip ridge of the fingerprint as a conductive wire. The fingertip ridge acts like a variable resistor, and the fingertip valley acts like an open circuit. The voltage drop crossing the fingertip ridge makes a sample trajectory signal, which shows a resistance characteristic of a human skin. This sample trajectory signal is collected at the input 32 by means of an analog-digital converter 34 which changes an analog signal into a digital bit stream. The output of the A/D converter 34 is configured into an N bit data line 36 connected to the processor 40 allowing the transmission of the digital sample trajectory signal. In addition, the processor 40 includes a verifying output 44, which supplies a signal during verification. The processor 40 may include a processor input 42 which selectively allows data transmission through a data interface from an external storage device. The input 42 is input to the processor in order to compare the sample trajectory signal and the reference trajectory signal in real time. As an alternative, if the data interface is not installed, the processor may be directly connected to a storage device 48 through the storage device interface 46. The storage device may be selectively programmed together with the reference trajectory information of the user.

This conventional semiconductor fingerprint sensing system generates a sample trajectory signal for distinguishing valleys and ridges of the fingerprint, and then discriminates truth or falsehood of the fingerprint by comparing this sample trajectory signal with a reference trajectory signal using the A/D converter.

However, the usage of the A/D converter like the above fingerprint sensing system has several problems as follows.

Size and energy consumption of the A/D converter become problems caused in manufacture of the semiconductor fingerprint sensor. The A/D converter used in the prior art occupies significant area on the semiconductor wafer of the semiconductor fingerprint system, and thereby the wafer area should be increased together with the energy consumption. Thus, it is substantially difficult to realize and miniaturize the fingerprint sensing system having the semiconductor fingerprint sensor, which uses the same number of A/D converters as the sensing arrays for extracting the fingerprint pattern for the purpose of identification or verification.

There has been an attempt to overcome this limitation by sharing a small number of A/D converters in the fingerprint sensing array by use of such as a multiplexer. However, considering the size, energy consumption and required performance of the A/D converter circuit, A/D converters still have much possibility to increase costs and difficulty for manufacture the semiconductor fingerprint sensing system though the small number of A/D converters are used.

Thus, in order to make a fingerprint sensing system which is easily miniaturized and light-weighted and requires low manufacture costs as objected in the prior art, there is required a fingerprint sensing system not using the A/D converter.

### DISCLOSURE OF INVENTION

The present invention is designed on the basis of the technical needs of the prior art, and therefore an object of the present invention is to provide fingerprint sensing apparatus and method which are capable of detecting an inherent fingerprint pattern from the time value that is required for a fingerprint signal to reach a certain reference value.

Another object of the present invention is to provide fingerprint sensing apparatus and method which may detect a fingerprint pattern with high sensitivity though electrical characteristics of the skin change.

Still another object of the present invention is to provide fingerprint sensing apparatus and method which may detect an inherent fingerprint pattern by use of electric charging or discharging characteristics of fingerprint impedance.

Further another object of the present invention is to provide a fingerprint sensing apparatus which may improve the detect accuracy of the fingerprint signal on the basis of the detected results of the fingerprint pattern.

In order to accomplish the above object, a fingerprint sensing apparatus of the present invention includes a fingerprint signal generating unit for generating successive analogue fingerprint signals which reflect fingerprint impedances at each sensing point according to characteristics of a fingerprint; a fingerprint signal converter for converting the analogue fingerprint signals into digital fingerprint signals by counting a time which is required for the analogue fingerprint signals to reach a predetermined reference value; and a signal processing unit for extracting an inherent fingerprint pattern from a time-variable characteristic of the fingerprint impedances symbolized by the digital fingerprint signals.

Thereby, the inherent fingerprint pattern is extracted from time values which are required for the fingerprint signals to reach a predetermined magnitude.

At this time, the analogue fingerprint signal shows an inherent electric charging or discharging characteristic of each fingerprint impedance. Thus, the present invention makes it possible to extract an inherent fingerprint pattern from the charging/discharging characteristics of the fingerprint impedance.

The fingerprint signal generating unit preferably includes a plurality of sensing electrodes arranged in matrix in order to contact with fingertips (ridges and valleys of the fingerprint); and a charging/discharging control unit for controlling electric charges in order to charge the fingerprint impedance formed between the fingerprint and the sensing electrode by applying charges to the sensing electrode or discharge the charge charged in the fingerprint impedance.

In addition, the fingerprint signal converting unit may digitally count the time required for the analogue fingerprint signal to reach a predetermined reference value from a count reference point, and then transmits the count value to the signal processing unit in order to convert the analogue fingerprint signal into a digital time count on the basis of the time-variable characteristic.

In this reason, the fingerprint signal converting unit may include a determination unit for determining whether the analogue fingerprint signal reaches a predetermined reference value; and a counting unit for digitally counting the time required for the analogue fingerprint signal to reach to the reference value from a counting reference point by means of counting of the clock signals.

In addition, the fingerprint sensing apparatus of the present invention may further include a reference signal generating unit for generating a reference signal to be applied to the determination unit; and a clock signal generating unit for clock signals to be applied to the counting unit.

In addition, the fingerprint sensing apparatus of the present invention may further include a controller for generating a signal use for controlling the magnitude of the reference signal after the signal processing unit feeds back the processing results thereto, and for generating a signal used for controlling a clock period and a generation point of the clock signal after the signal processing unit feeds back the processing results thereto.

In another aspect of the present invention, there is also provided a fingerprint sensing method, which includes the steps of: charging a fingerprint impedances formed between ridges and valleys of the fingerprint and electrodes by applying charges to the fingerprint impedances for initiation; discharging the charged fingerprint impedances, and then counting the time required for the discharged fingerprint signal to reach a predetermined reference fingerprint signal from a predetermined discharging point; and extracting an inherent pattern of the fingerprint impedance on the basis of the time count value.

In still another aspect of the present invention, there is also provided a fingerprint sensing method, which includes the steps of: discharging a fingerprint impedances formed between ridges and valleys of the fingerprint and electrodes by removing charges from the fingerprint impedances for initiation; charging the discharged fingerprint impedances, and then counting the time required for the charged fingerprint signal to reach a predetermined reference fingerprint signal from a predetermined charging point; and extracting an inherent pattern of the fingerprint impedance on the basis of the time count value.

At this time, a magnitude of the reference fingerprint signal is preferably suitably adjusted according to the difference of electric characteristic of the skin in order to improve accuracy of the extracted fingerprint pattern, a period or a generation point of the clock signal is also preferably suitably controlled.

Other object and advantages of the invention will be described later, and understood by the embodiments of the invention. In addition, the objects and advantages of the invention may be realized by means revealed in the appended claims and their combinations.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic functional diagram showing a fingerprint sensing system according to the prior art;

FIG. 2 is a sectional view showing a skin resistance sensing array;

FIG. 3 shows graphs for expressing time-variable characteristics of the fingerprint signal, in which FIG. 3a shows the way of measuring fingerprint data at a certain time (Tt), FIG. 3b shows the way of measuring fingerprint data by use of a time-variable discharging characteristic of the fingerprint signal, and FIG. 3c shows the way of measuring fingerprint data by use of a time-variable charging characteristic of the fingerprint signal;

FIG. 4 is a schematic functional diagram showing the fingerprint sensing apparatus according to a preferred embodiment of the present invention;

FIG. 5 shows graphs for expressing the fingerprint signal change caused by the change of electric characteristic, in which FIG. 5a is a graph showing that the fingerprint signal changes according to the humidity of the skin, and FIG. 5b is a graph showing the way of improving the sampling accuracy by changing the magnitude of the reference fingerprint signal conforming to the characteristic of the fingerprint signal;

FIG. 6 shows a fingerprint signal generating unit according to a preferred embodiment of the present invention;

FIG. 7 shows another example of the fingerprint signal generating unit of FIG. 6;

FIG. 8 shows a signal converter according to a preferred embodiment of the present invention;

FIG. 9 is another example of the signal converter of FIG. 8;

FIG. 10 is a timing chart for illustrating the correlation between various signals according to the present invention;

FIG. 11 is a flowchart for illustrating the fingerprint detecting process according to a preferred embodiment of the present invention; and

FIG. 12 is a flowchart for illustrating the fingerprint detecting process according to another embodiment of the present invention.

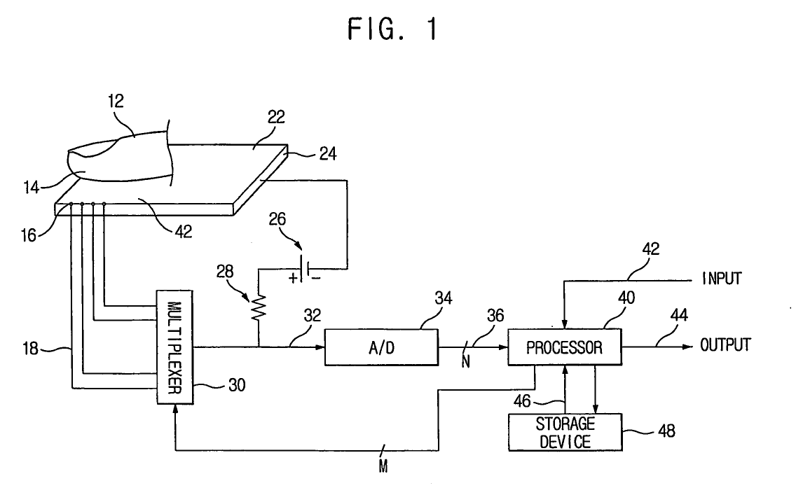

### BEST MODES FOR CARRYING OUT THE INVENTION

Hereinafter, preferred embodiments of the present invention will be described in detail with reference to the accompanying drawings.

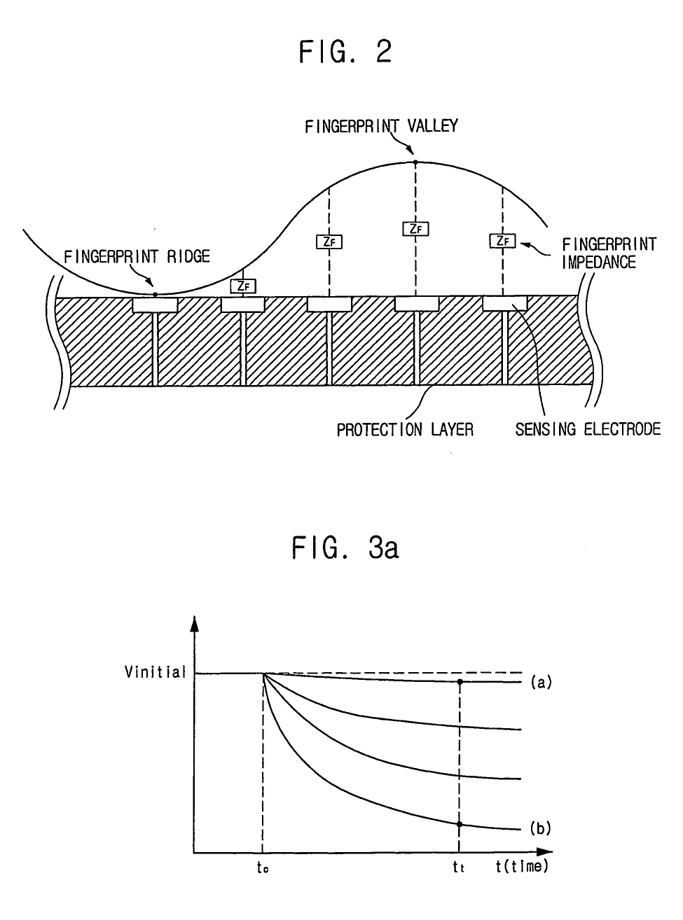

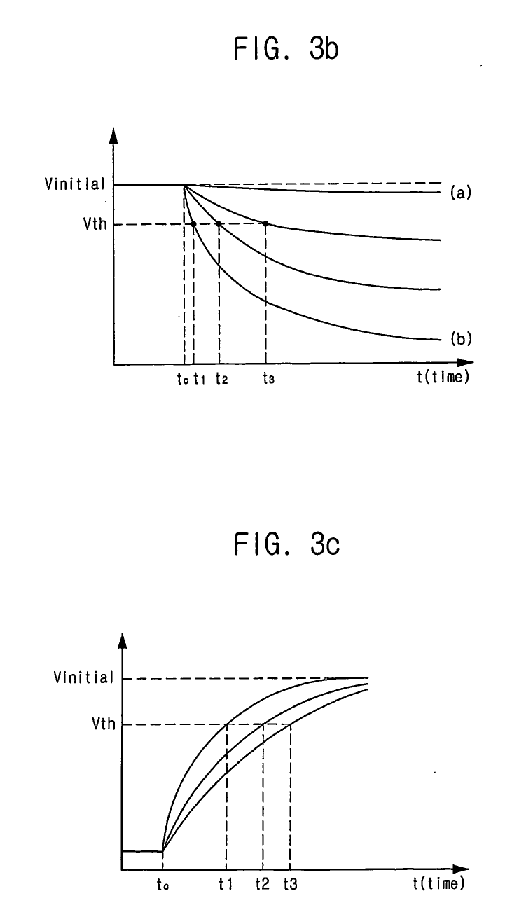

At first, the technical principles of the present invention are described with reference to FIGS. 2 and 3 in advance of explaining the detailed configuration of the present invention.

As shown in FIG. 2, if a fingerprint is contacted to a fingerprint sensor, fingerprint impedance (Z_{F}) is generated between the sensing electrode and the fingerprint. This fingerprint impedance (Z_{F}) includes a resistance component (R_{F}) and a capacitance component (C_{F}).

The resistance of the fingerprint impedance (Z_{F}) is high at valleys of the fingerprint, and relatively low at ridges of the fingerprint. In other words, the fingerprint impedance (Z_{F}) has a close correlation to the distance between the fingerprint and the sensing electrode.

Thus, as time goes in the contacted state, the fingerprint signal is exponential-functionally decreased (or, showing electric discharging) or increased (or, showing electric charging) as shown in FIGS. 3a and 3b.

At first, the electric discharging of the fingerprint impedance is described below with reference to FIG. 3a.

If the supply of charges is stopped while the charges are fully charged in the fingerprint impedance (Tc), the fingerprint signal (V_{S}) is exponential-functionally decreased with a time constant (R_{F}C_{F}) from an initial value (Vᵢₙᵢₜᵢₐₗ). This time constant of the fingerprint signal is dependent on the fingerprint impedance having close correlation to the distance between the fingerprint and the sensing electrode. Thus, a magnitude of the fingerprint impedance may be found by analyzing the discharging characteristic of the fingerprint impedance, and an inherent pattern of the fingerprint may be detected on the basis of the magnitude of the fingerprint impedance.

Since a changing rate of the fingerprint signal is determined by RC time constant, the decrease of the fingerprint signal (b) at the ridge is relatively larger than the fingerprint signal (a) at the valley.

Thus, the present invention indirectly extracts a pattern of the fingerprint by measuring the time required for a changing amount of the fingerprint signal to satisfy a specific magnitude.

As shown in FIG. 3b, it may be known that the time required for generating a certain magnitude (Vₜₕ) of the fingerprint signal also has correlation to the distance between the fingerprint and the sensing electrode.

In other words, the times required for reaching a reference value (Vₜₕ) are different at the valley (a) and at the ridge (b). This is because the different fingerprint impedances (Z_{F}) at the valley and at the ridge result in different changing rates of the fingerprint signal. Thus, the reference value (Vₜₕ) is constantly set, and the magnitude of the fingerprint impedance may be measured by calculating the times (t₁, t₂, t₃) required for the fingerprint impedance to reach the reference value (Vₜₕ) from a point (T_{C}) when the fingerprint starts discharging. In addition, if the fingerprint impedance is once measure, the distance between the fingerprint and the sensing electrode may be analogized, which also makes it possible to reproduce the pattern of the fingerprint therefrom.

FIG. 3c shows a discharging characteristic curve of the fingerprint impedance.

Similar to the fact that the fingerprint pattern may be extracted from the discharging characteristic of the fingerprint impedance, the fingerprint pattern may also be extracted from the charging characteristic of the fingerprint impedance. It is because the changing rate of the fingerprint impedance is also dominated by RC time constant. Thus, an inherent pattern of the fingerprint may be reproduced by supplying charges to the fingerprint impedance existing between the fingerprint and the sensing electrode and then analyzing the change of the charging characteristic according to the time.

As described above, the present invention is designed on the basis of the above-mentioned technical principle.

Now, the fingerprint sensing apparatus and method based on the above-described principle according to preferred embodiments of the present invention will be described with reference to accompanying drawings.

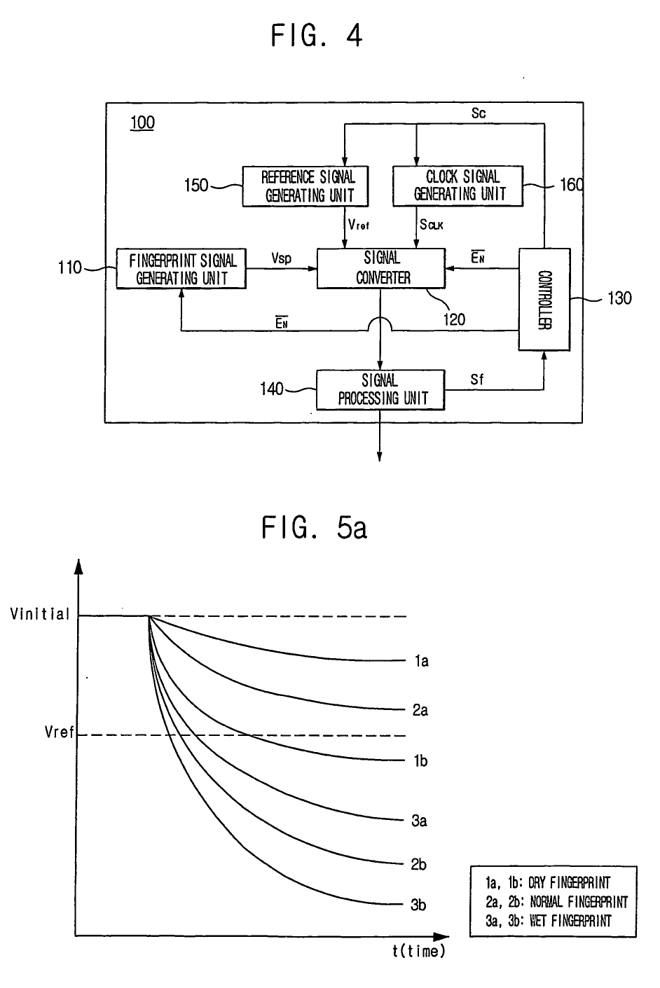

FIG. 4 is a schematic functional diagram showing the fingerprint sensing apparatus according to the present invention. As shown in FIG. 4, the fingerprint sensing apparatus 100 of the present invention includes a fingerprint signal generating unit 110, a signal converter 120, a controller 130, a signal processing unit 140, a reference signal generating unit 150 and a clock signal generating unit 160.

If a fingerprint is contacted with the fingerprint sensing apparatus of the present invention, the fingerprint signal generating unit 110 generates an analogue fingerprint signal (V_{SP}) which reflects charging/discharging characteristics of the fingerprint impedance at each sensing point (or, points where the sensing electrodes are positioned). The analogue fingerprint signal (V_{SP}) output from the fingerprint signal generating unit 110 is converted into a digital count signal at the signal converter 120. This digital count signal is processed in the signal processing unit 140 so that an inherent fingerprint pattern of the corresponding fingerprint may be detected.

In addition, the signal processing unit 140 feeds back signal-processed results to the controller 130, and the controller 130 analyzes the feedback signal and then applies a control signal (S_{C}) to the reference signal generating unit 150 and the clock signal generating unit 160 so as to detect a fingerprint pattern having higher accuracy. By using this control signal (S_{C}), a magnitude of the reference signal (V_{ref}) applied to the signal converter 120 and period and generating point of the clock signal (S_{clk}) may be controlled. On the other hand, the controller 130 provides an enable signal (EN) to the fingerprint signal generating unit 110 and the signal converter 120, respectively. The enable signal is used for controlling the supply of charges at the fingerprint signal generating unit, and for controlling the counting point of the clock signal at the signal converter.

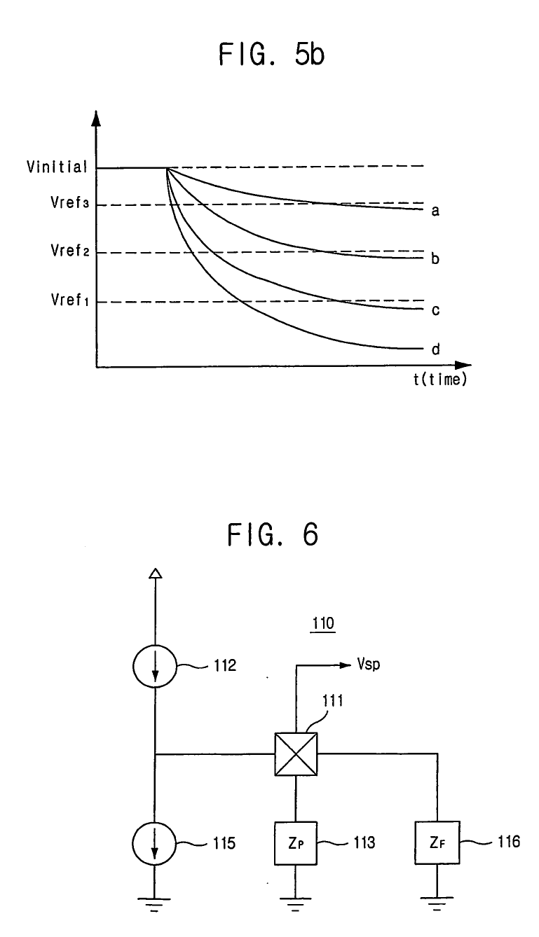

Now, more specified embodiments for each functional element of the fingerprint sensing apparatus according to the present invention will be described with reference to FIGS. 5 to 10.

Fingerprint Signal Generating Unit

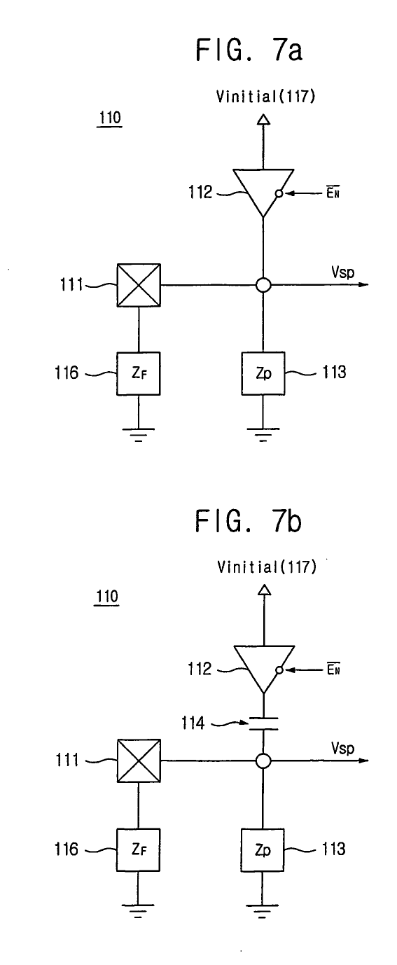

The fingerprint signal generating unit 110 is preferably configured as shown in FIGS. 6 and 7. This fingerprint signal generating unit 110 generates successive analogue fingerprint signals which reflect the fingerprint impedance at each sensing point according to the characteristics of the fingerprint.

In other words, when the fingerprint to be detected is contacted on the sensing electrodes arranged in matrix, the fingerprint signal generating unit 110 generates an analogue fingerprint signal (Vsp) which symbolizes the charging/discharging characteristics of the fingerprint impedance by supplying or discharging charges to/from the fingerprint impedance formed between the fingerprint and the sensing electrodes.

Referring to FIGS. 6 and 7, the fingerprint signal generating unit 110 includes a sensing electrode 111, a fingerprint impedance 113, a parasitic impedance 116 and a charging/discharging control units 112 and 115.

The sensing electrode 111 is directly contacted with the skin on which the fingerprint to be detected is formed. There are a plurality of sensing electrodes 111 are arranged in matrix on the surface of the fingerprint sensor as shown in FIG. 2.

The fingerprint impedance 113 is formed between the valleys & ridges of the fingerprint and the sensing electrodes 111 as shown in FIG. 2 when the fingerprint is contacted with the sensing electrodes 111. This fingerprint impedance 113 has resistance and capacitance. Generally, at the valley of the fingerprint impedance, the resistance is high and the capacitance is low. On the other hand, at the ridge of the fingerprint, the resistance is low and the capacitance is high.

The parasitic impedance 116 is an inherent impedance of the sensing apparatus itself which is formed between the sensing electrode and the ground terminal (GND) while the fingerprint is not contacted with the sensing electrode. This parasitic impedance 116 has relatively higher capacitance (about 100 times) and relatively lower resistance than the fingerprint impedance 113. Thus, the parasitic impedance 116 plays a role of decreasing or damping the distortion of the fingerprint signal caused by the capacitance of the fingerprint impedance 113.

The charging/discharging control units 112 and 115 play a role of charging or discharging impedance formed between the sensing electrode and the ground terminal by applying or removing charges to/from the sensing electrode while the fingerprint is contacted with the sensing electrode.

This charging/discharging control units may be configured using current sources 112 and 116 as shown in FIG. 6, or using a voltage source 117 and a digital switching element 112 as shown in FIG. 7.

At first, in case of FIG. 6, the charging/discharging control units are configured using two current sources among which the current source 112 is operated when charging the sensing electrode and the current source 115 is operated when charges are discharged through the sensing electrode. The current sources 112 and 115 may adopt both of a fixed current source for supplying fixed current or a variable current source for supplying variable current. In particular, in case the current sources 112 and 115 are variable current sources, the charging/discharging rate may be controlled as desired by adjusting the amount of charges.

In case of FIG. 6, while charging, the current source 112 operates, while the current source 115 does not operate. On the other hand, when discharging, the current source 115 operates and the current source 112 does not operate. Thus, there are preferably positioned switching elements between the current sources 112 and 115 and the sensing electrodes, respectively.

On the other hand, FIG. 7 adopts the voltage source 117 as the charging/discharging control unit, and uses a digital switching element such as a tri-state buffer 112 in order to control the operation of the voltage source.

The voltage source 117 is capable of supplying both a constant fixed voltage and a variable voltage.

The tri-state buffer 112 connects the voltage source 117 to the sensing electrode 111 and supplies charges to the fingerprint impedance 116 when “ON” signal is applied to the enable terminal (EN), while it quits the supply of charges by cutting off the connection between the voltage source 117 and the sensing electrode 111 when “OFF” signal is applied to the enable terminal (EN).

The enable signal (EN) is applied from the controller 130 of FIG. 4 to a gate terminal of the tri-state buffer 112 of the fingerprint signal generating unit 110.

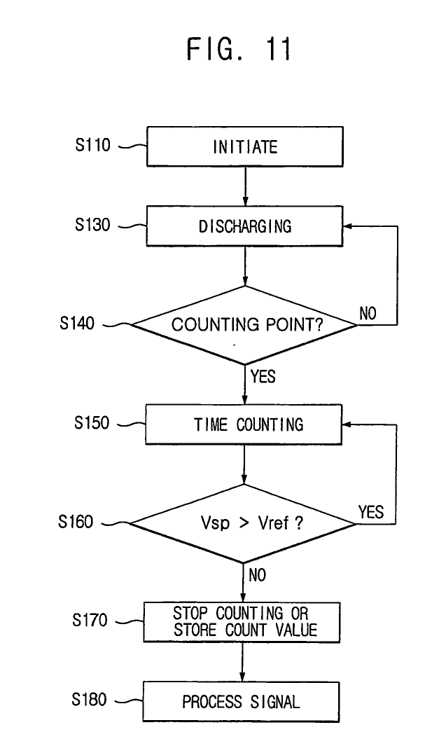

FIG. 10 shows the enable signal (EN) applied to the tri-state buffer 112 and the characteristic of the analogue fingerprint signal (V_{SP}) shown at the sensing electrode 111 since the charges are supplied or intercepted to the sensing electrode 111 according to the enable signal (EN).

As shown in FIG. 10, if the enable signal (“ON” signal) is applied to the tri-state buffer 112 from the controller 130 while the fingerprint is contacted with the sensing electrodes 111, charges supplied from the voltage source 117 are applied to the sensing electrodes 111 and thus the fingerprint impedance is charged. If the enable signal (“OFF” signal) is applied to the tri-state buffer 112 from the controller 130 while the fingerprint impedance is fully charged, the tri-state buffer 112 becomes a high impedance state, thereby intercepting the electric connection between the voltage source 117 and the sensing electrode 111. Thus, the charges charged in the fingerprint impedance are discharged with a certain time constant as shown in FIG. 5b.

Accordingly, the analogue signal (V_{SP}) transmitted to the signal converter 120 through the fingerprint signal generating unit 110 has a shape as shown in FIG. 10.

As described above, in case the charges supplied from the charging/discharging control units 112, 115 and 117 while the fingerprint is contacted with the sensing electrodes 111 are directly applied to the fingerprint, the finger and human body become directly exposed to DC current. Thus, a large amount of current from hundreds or thousands of sensing electrodes flows through the human body at once, which may be harmful to the human body. In addition, this causes great energy consumption through the sensing electrodes 111 during the charging process.

FIG. 7b shows another modified example of the fingerprint signal generating unit 110 according to the present invention in which a shielding unit 114 is further provided for preventing the DC current of the charges supplied by the voltage source or the current source from being directly applied to the human body through the finger.

The fingerprint signal generating unit 110 of FIG. 7b is substantially identical to that of FIG. 7a, except that a capacitor 114 is further positioned between the tri-state buffer 112 and the sensing electrode 111. The capacitor 114 is used for shielding the DC current applied from the current source or the voltage source so that the DC current is not directly supplied to the human body.

Fingerprint Signal Converter

As mentioned above, the signal (V_{SP}) reflecting the characteristic of the fingerprint impedance output from the fingerprint signal generating unit 110 is an analogue signal as shown in FIG. 10. Thus, there is a need to convert this analogue signal into a digital signal which may be recognized by the signal processing unit 120.

To convert an analogue signal into a digital signal, the analogue-digital converting device is most commonly used. This analogue-digital converting device is operated for sampling analogue signals according to their magnitudes, and then quantizing the sampled signals.

Of course, the fingerprint signal converter of the present invention may adopt the above-mentioned conventional analogue-digital converting device. However, the conventional analogue-digital converting device uses an analogue circuit which is complicate, requiring a lot of costs for manufacture and consuming much energy.

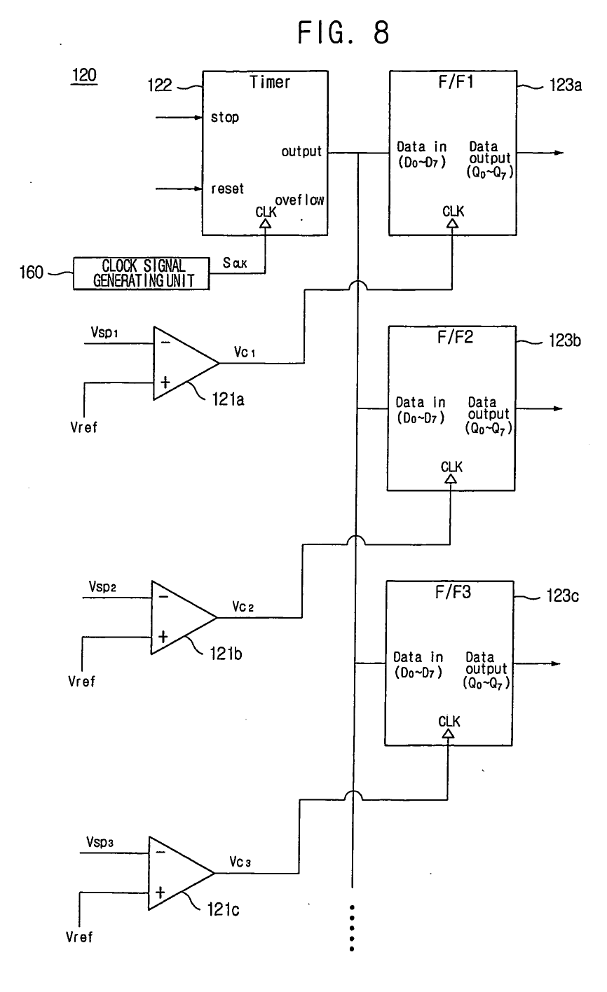

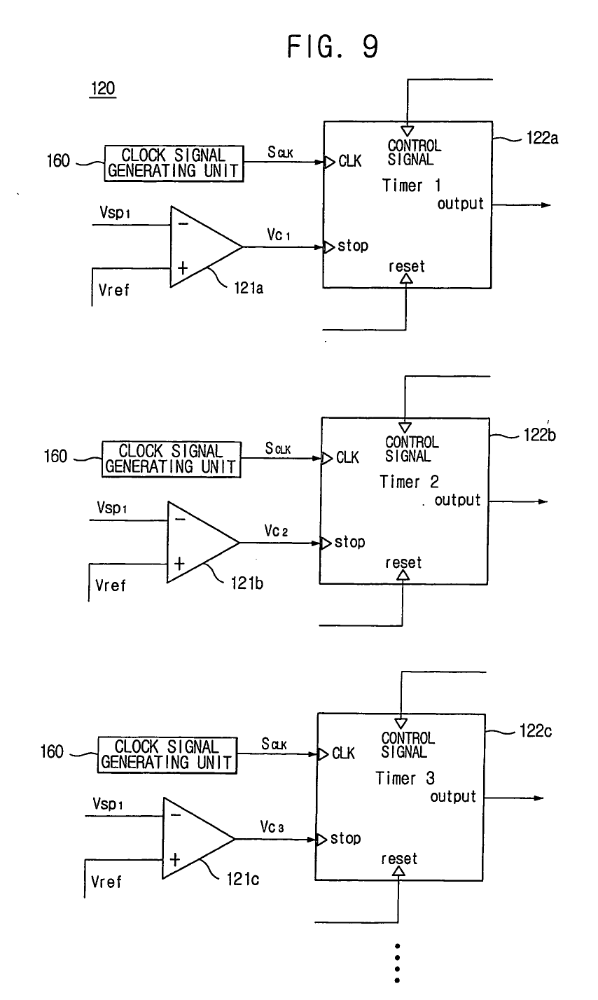

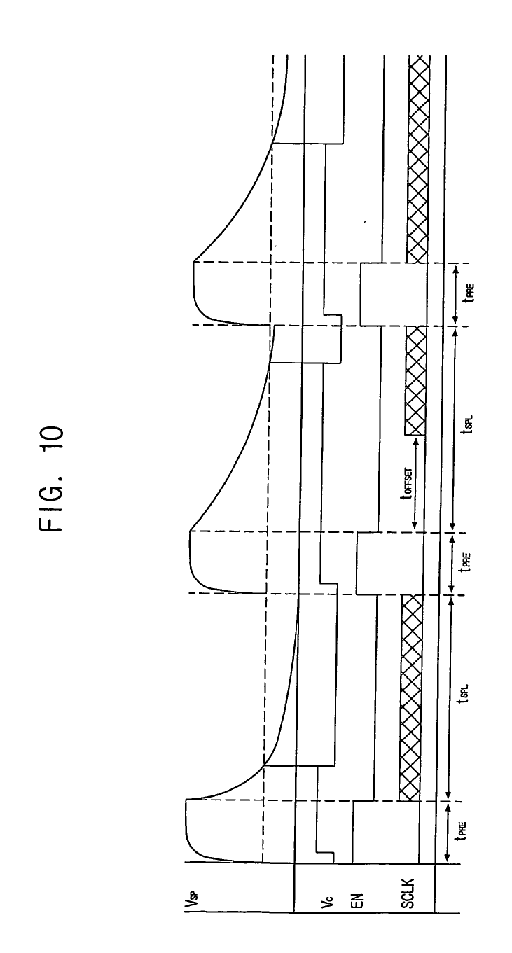

Thus, this embodiment of the present invention uses a digital converting circuit which converts an analogue signal into a digital signal by counting the time required for an analogue fingerprint signal to reach a predetermined reference value, as shown in FIGS. 8 and 9.

At first, FIG. 8 shows an example of the signal converter 120 composed of a timer 122, a plurality of flip-flops 123a ˜123c and a plurality of comparators 121a˜121c.

The timer 122 counts clock signals applied to CLK terminal, and transmits this count value to the flip-flop 123. The clock signal (S_{CLK}) is input from the clock signal generating unit 160, and this clock signal may have t_{OFFSET} or changes a clock period according to the control signal of the controller 130, as shown in FIG. 10. In other words, the controller 130 may control a generation point or a period of the clock signal on the basis of the result value fed back by the signal processing unit 140. As described above, by controlling the generation point or period of the clock signal, it becomes possible to set the sampling area of the analogue fingerprint signal as desired or control a counting rate of the timer. Thus, this also makes it possible to reproduce a fingerprint pattern having high resolution regardless of personal difference of the fingerprint signal or change of environments.

The flip-flop 123 is preferably an 8 bit falling-edge triggered D Flip-Flop which determines input data (D₀˜D₇), which is input from the timer 122 at the falling edge of the signal (V_{C}) input from the comparator 121, as output data (Q₀˜Q₇).

The comparator 121 compares the analogue fingerprint signal (V_{SP}) transmitted from the fingerprint signal generating unit 110 with the reference signal (V_{ref}) input from the reference signal generating unit 150, and then sends “0” value when the analogue fingerprint signal (V_{SP}) is smaller than the reference signal (V_{ref}), and sends “1” value when the analogue fingerprint signal (V_{SP}) is greater than the reference signal (V_{ref}).

The magnitude of the reference signal (V_{ref}) is determined by the controller 130, and it may be changed according to fingerprint state or personal difference. Referring to FIG. 5a, if the fingerprint impedance starts discharging at its initiated state (Vᵢₙᵢₜᵢₐₗ) caused by the full charging, it will be understood that the signal is decreased more rapidly at a dry fingerprint 1a and 1b (1a: valley, 1b: ridge) than a wet fingerprint 3a and 3b (3a: valley, 3b: ridge). Thus, if the magnitude of the reference signal is fixed as shown in FIG. 5a, it is substantially impossible to detect the pattern of the dry fingerprint. Accordingly, the fingerprint signal with reliability may be sampled regardless of the humidity of the fingerprint by suitably adjusting levels (V_{ref1}, V_{ref2}, V_{ref3}) of the reference signal according to the state of the fingerprint as shown in FIG. 5b.

FIG. 9 shows another example of the signal converter 120 composed of a plurality of master timers 122 and a plurality of comparators 121a ˜121c.

The master timer 122a ˜122c applies clock signals (S_{CLK}) input from the clock signal generating unit 160 and at the same time starts counting the clock signals, and stops counting when comparative signals (V_{C1}˜V_{C3}) input from the comparators 121a˜121c drop from “1” to “0”, and then outputs the calculated digital count. The digital count value output as above is signal-processed by the signal processing unit 140, and then output for detection of the fingerprint pattern or fed back to the controller 130.

According to this feedback signal (S_{f}), the controller 130 controls the generation point of the clock signal or controls the period of the clock signal in order to detect a precise fingerprint pattern. Or else, the controller 130 generates a control signal for controlling the magnitude of the reference signal and then applies this control signal to the clock signal generating unit 160 and the reference signal generating unit 150.

Now, a fingerprint sensing method according to a preferred embodiment of the present invention is described with reference to FIGS. 10 to 12.

Using Discharging Characteristic of Fingerprint Impedance

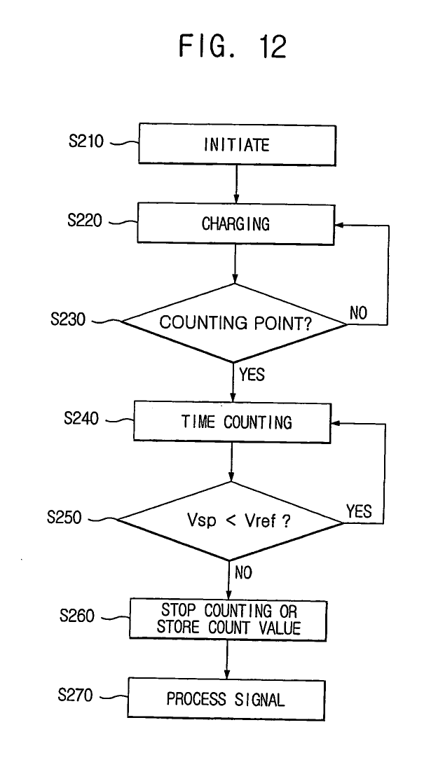

At first, a method for detecting an inherent pattern of a fingerprint by use of the discharging characteristic of the fingerprint impedance is described with reference to FIG. 11.

If contacting a fingerprint of the finger to the sensing electrode array of the fingerprint sensor, charges are supplied through the sensing electrodes so that the fingerprint impedance is charged to a predetermined level. If the fingerprint impedance is fully charged as above and then initiated, the supply of charges applied to the sensing electrodes is stopped (S110).

If the charge supply to the sensing electrodes is stopped, an analogue fingerprint signal detected at the sensing electrodes by the resistance existing in the fingerprint impedance is decreased by a predetermined time constant. In other words, the charges charged in the fingerprint impedance starts to be discharged at a predetermined ratio (S130).

Clock signals having a predetermined period are digitally counted in order to count the discharging time of the fingerprint signal at once or after a certain interval when the discharging is started (S140 and S150).

At this time, the magnitude of the fingerprint signal is compared with a predetermined reference signal. If the magnitude of the fingerprint signal is equal to or smaller than the reference signal, the time required for the fingerprint signal to reach a predetermined reference level is calculated by stopping the counting of time clocks or storing the count value (S170).

Thus, an inherent pattern of the fingerprint may be indirectly reproduced by obtaining the fingerprint impedance at the corresponding sensing point from the count value and calculating the distance between the fingerprint and the sensing electrode on the basis of the fingerprint impedance (S180).

Using Charging Characteristic of Fingerprint Impedance

Now, a method for detecting an inherent pattern of a fingerprint by use of the charging characteristic of the fingerprint impedance is described with reference to FIG. 12.

At first, voltage levels of the sensing electrodes are initiated to be uniform by discharging charges existing in the sensing electrodes while a fingerprint of the finger is contacted with the sensing electrode array (S210). If the sensing electrodes are initiated, charges are supplied to the sensing electrodes in order to slowly charging the fingerprint impedance formed between the fingerprint and the sensing electrode (S220).

Clock signals having a predetermined period are digitally counted in order to count the charging time of the fingerprint signal at once or after a certain interval when the charging is started (S230 and S240).

At this time, the magnitude of the fingerprint signal is compared with a predetermined reference signal. If the magnitude of the fingerprint signal is equal to or greater than the reference signal, the time required for the fingerprint signal to reach a predetermined reference level is calculated by stopping the counting of time clocks or storing the count value (S260).

Thus, an inherent pattern of the fingerprint may be indirectly reproduced by obtaining the fingerprint impedance at the corresponding sensing point from the count value and then calculating the distance between the fingerprint and the sensing electrode on the basis of the fingerprint impedance (S270).

In the above embodiments of the present invention, the fingerprint signal generating unit and the signal converter are limitedly described using the configurations shown in the drawings. However, the fingerprint signal generating unit and the signal converter are not limited to the above-mentioned configuration, they may be replaced with other circuits or devices having the same functions if they are suitable for accomplishing the objects of the invention and realizing the technical principle of the invention.

### INDUSTRIAL APPLICABILITY

The fingerprint sensing apparatus according to the present invention indirectly detects a fingerprint pattern from the time-variable characteristics of the fingerprint impedance during the electric charging or discharging.

Thus, the fingerprint sensing apparatus of the present invention may be accumulated in one chip since all components of the apparatus may be realized using digital circuits.

In addition, the fingerprint sensing apparatus of the present invention is capable of reproducing a fingerprint pattern having high resolution and reliability regardless of personal difference or humidity of the fingerprints.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A fingerprint sensing apparatus comprising:
means for generating successive analogue fingerprint signals which reflect fingerprint impedances at each sensing point according to characteristics of a fingerprint;
means for converting the analogue fingerprint signals into digital fingerprint signals by counting a time which is required for the analogue fingerprint signals to reach a predetermined reference value; and
signal processing means for extracting an inherent fingerprint pattern from a time-variable characteristic of the fingerprint impedances symbolized by the digital fingerprint signals,
whereby the inherent fingerprint pattern is extracted from time values which are required for the fingerprint signals to reach a predetermined magnitude.

2. A fingerprint sensing apparatus according to claim 1,
wherein the analogue fingerprint signal shows an inherent electric charging or discharging characteristic of each fingerprint impedance.

3. A fingerprint sensing apparatus according to claim 2, wherein the fingerprint signals generating means includes:
a plurality of sensing electrodes arranged in matrix in order to contact with fingertips (ridges and valleys of the fingerprint); and
charging/discharging control means for controlling electric charges in order to charge the fingerprint impedance formed between the fingerprint and the sensing electrode by applying charges to the sensing electrode or discharge the charge charged in the fingerprint impedance.

4. A fingerprint sensing apparatus according to claim 3,
wherein the charging/discharging control means controls the charging characteristic of the fingerprint impedance by controlling the amount of charges applied to the sensing electrode.

5. A fingerprint sensing apparatus according to claim 4,
wherein the fingerprint signal generating means further includes means for shielding direct DC current which is supplied from the charging/discharging control means and flows through the fingerprint.

6. A fingerprint sensing apparatus according to claim 5,
wherein the shielding means is a capacitor positioned between the sensing electrode and the charging/discharging control means.

7. A fingerprint sensing apparatus according to claim 2,
wherein the fingerprint signal converting means converts the analogue fingerprint signal into a digital time count on the basis of a time-variable characteristic of the analogue fingerprint signal.

8. A fingerprint sensing apparatus according to claim 7,
wherein the fingerprint signal converting means digitally counts the time required for the analogue fingerprint signal to reach a predetermined reference value from a count reference point, and then transmit the count value to the signal processing means.

9. A fingerprint sensing apparatus according to claim 8,
wherein the count reference point is determined based on a charging initiating point or a discharging initiating point.

10. A fingerprint sensing apparatus according to claim 9, wherein the fingerprint signal converting means includes:
means for determining whether the analogue fingerprint signal reaches a predetermined reference value; and
means for digitally counting the time required for the analogue fingerprint signal to reach to the reference value form a counting reference point by means of counting of the clock signals.

11. A fingerprint sensing apparatus according to claim 10,
wherein the determination means is a comparator for comparing the analogue fingerprint signal with a predetermined reference signal and then outputting a binary state code on the basis of the comparison results.

12. A fingerprint sensing apparatus according to claim 10, further comprising:
means for generating a reference signal to be applied to the determination means; and
means for clock signals to be applied to the counting means.

13. A fingerprint sensing apparatus according to claim 12, further comprising:
control means for generating a signal use for controlling the magnitude of the reference signal after the signal processing means feeds back the processing results thereto.

14. A fingerprint sensing apparatus according to claim 12, further comprising:
control means for generating a signal used for controlling a clock period and a generation point of the clock signal after the signal processing means feeds back the processing results thereto.

15. A fingerprint sensing method comprising the steps of:
charging a fingerprint impedances formed between ridges and valleys of the fingerprint and electrodes by applying charges to the fingerprint impedances for initiation;
discharging the charged fingerprint impedances, and then counting the time required for the discharged fingerprint signal to reach a predetermined reference fingerprint signal from a predetermined discharging point; and
extracting an inherent pattern of the fingerprint impedance on the basis of the time count value;
whereby an inherent fingerprint pattern is extracted from the discharging characteristic of the fingerprint impedance.

16. A fingerprint sensing method according to claim 15,
wherein the predetermined discharging point is the time when the charges charged in the fingerprint impedance start discharging.

17. A fingerprint sensing method according to claim 15,
wherein the predetermined discharging point is a time after the charges charged in the fingerprint impedance start discharging and before the charges reach the reference fingerprint signal.

18. A fingerprint sensing method according to claim 16,
wherein a magnitude of the reference fingerprint signal is adjusted according to the difference of electric characteristic of the skin in order to improve accuracy of the extracted fingerprint pattern.

19. A fingerprint sensing method according to claim 15, wherein the time counting step includes:
counting clock signals having a predetermined period from the predetermined discharging point; and
stopping the counting of the clock signals or storing the count value at a point when reaching the predetermined reference signal,
whereby the time required for the discharged fingerprint signal to reach the reference signal from the predetermined discharging point is counted.

20. A fingerprint sensing method according to claim 19,
wherein a period or a generation pint of the clock signal is controlled according to the difference of electric characteristic of the skin in order to improve accuracy of the extracted fingerprint pattern.

21. A fingerprint sensing method according to claim 15,
wherein the time count value is a digital value composed of n bits.

22. A fingerprint sensing method comprising the steps of:
discharging a fingerprint impedances formed between ridges and valleys of the fingerprint and electrodes by removing charges from the fingerprint impedances for initiation;
charging the discharged fingerprint impedances, and then counting the time required for the charged fingerprint signal to reach a predetermined reference fingerprint signal from a predetermined charging point; and
extracting an inherent pattern of the fingerprint impedance on the basis of the time count value,
whereby an inherent fingerprint pattern is extracted from the charging characteristic of the fingerprint impedance.

23. A fingerprint sensing method according to claim 22,
wherein the charging rate is controlled by adjusting an amount of charges applied to the fingerprint impedance.

24. A fingerprint sensing method according to claim 22,
wherein the predetermined charging point is the time when the charges are applied to the fingerprint impedance to start charging.

25. A fingerprint sensing method according to claim 22,
wherein the predetermined charging point is a time after the charges are applied to the fingerprint impedance to start discharging and before the charges reach the reference fingerprint signal.

26. A fingerprint sensing method according to claim 24,
wherein a magnitude of the reference fingerprint signal is adjusted according to the difference of electric characteristic of the skin in order to improve accuracy of the extracted fingerprint pattern.

27. A fingerprint sensing method according to claim 22, wherein the time counting step includes:
counting clock signals having a predetermined period from the predetermined charging point; and
stopping the counting of the clock signals or storing the count value at a point when reaching the predetermined reference signal,
whereby the time required for the charged fingerprint signal to reach the reference signal from the predetermined charging point is counted.

28. A fingerprint sensing method according to claim 22,
wherein a period or a generation point of the clock signal is controlled according to the difference of electric characteristic of the skin in order to improve accuracy of the extracted fingerprint pattern.

29. A fingerprint sensing method according to claim 22,
wherein the time count value is a digital value composed of n bits.
